(19) United States
(12) Patent Application Publication
(10) Pub. No.: US 2017/0372427 A1
(43) Pub. Date: Dec. 28, 2017

(54) Quantum-Annealing Computer Method for Financial Portfolio Optimization

(71) Applicant: QC Ware Corp., Moffett Field, CA (US)

(72) Inventors: Matthew C. Johnson, Palo Alto, CA (US); Randall R. Correll, Mountain View, CA (US); Kay Giesecke, Woodside, CA (US); Peter L. McMahon, Menlo Park, CA (US); Vincent P. Su, Bellaire, TX (US)

(21) Appl. No.: 15/634,688

(22) Filed: Jun. 27, 2017

Related U.S. Application Data
(60) Provisional application No. 62/354,818, filed on Jun. 27, 2016.

(51) Int. Cl. G06Q 40/06; G06N 99/00

(52) U.S. Cl. CPC G06Q 40/06; G06N 99/002

(57) ABSTRACT

An improved method uses quantum processing devices to optimize a portfolio of financial assets. In one approach, a list of lots available for purchase is received. Each lot specifies financial assets included in the lot and a price to purchase the lot. A budget for the portfolio is also received. An objective function is formulated based on the list of lots and on the budget. The objective function has a form suitable for solution by a quantum processing device, which is used to optimize the objective function, thereby determining which lots are to be purchased.

### CROSS-REFERENCE TO RELATED APPLICATION(S)

This application claims priority under 35 U.S.C. §119(e) to U.S. Provisional Patent Application Ser. No. 62/354,818, “A quantum-annealing computer method for financial portfolio optimization,” filed Jun. 27, 2016. The subject matter of all of the foregoing is incorporated herein by reference in its entirety.

### BACKGROUND

### 1. Field of the Invention

This invention relates to the fields of quantum computing and financial portfolio optimization.

### 2. Description of Related Art

Quantum processing devices exploit the laws of quantum mechanics in order to perform computations. Quantum processing devices commonly use so-called qubits, or quantum bits, rather than the bits used in classical computers. Classical bits always have a value of either 0 or 1. Roughly speaking, qubits have a non-zero probability of existing in a superposition, or linear combination, of 0 and 1. Certain operations using qubits and control systems for computing using qubits are further described in U.S. patent application Ser. No. 09/872,495, “Quantum Processing System and Method for a Superconducting Phase Qubit,” which is hereby incorporated by reference in its entirety.

Although people have been aware of the utility of quantum algorithms for many years, only in the past decade has quantum computing hardware begun to become available at practical scales. Therefore, there is a need for new and useful applications of quantum computing hardware.

### BRIEF DESCRIPTION OF THE DRAWINGS

Embodiments of the disclosure have other advantages and features which will be more readily apparent from the following detailed description and the appended claims, when taken in conjunction with the accompanying drawings, in which:

FIG. 1 is a diagram illustrating a financial portfolio optimization method implemented using a quantum processing device.

FIG. 2 is a logical diagram of one instance of a platform component of a QCaaS architecture and system, including certain related infrastructure components, described in accordance with one or more embodiments of the invention.

FIG. 3 is a logical diagram of some of the various software modules and components of the Server-Side Platform Library in FIG. 2, described in accordance with one or more embodiments of the invention.

FIG. 4 is a logical diagram of some of the various software modules and components of the Client-Side Platform Library in FIG. 2, described in accordance with one or more embodiments of the invention.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION OF THE PREFERRED EMBODIMENTS

Portfolio optimization attempts to balance expected returns with risk, subject to one or more frictions or constraints on what financial assets may be purchased. One of these constraints is often the case that the portfolio manager can only choose from a specified set of discrete offerings. For example, various sellers may be offering stocks or other assets in lots of say 10,000 shares, or 20,000 shares, or some similar discrete amount, and the buyer is thus not able to purchase an arbitrary amount of the asset. The portfolio manager as a buyer is faced with discrete choices of purchasing the entire lot or not. This is often the case for institutional investors—for example, asset managers such as hedge funds, pension funds, mutual funds, and insurance firms who are engaged in actual trading of securities. The managers can trade through an exchange (like the NYSE), directly with one another or banks, or through other venues, for example dark pools. This can also be the case for smaller investors where they might specify their purchasing options as discrete lots and be faced with similar choices of what is the best combination of lots to include in their portfolio. When the menu of available offerings for purchase contains on the order of 100 or more different lots, deciding the most profitable set of non-conflicting bids is a difficult and complex problem, and can take more time—hours, days, or longer—than the portfolio manager has to compute the optimal solution. Current attempts use computer programs based on mathematical heuristic methods on digital computers that reduce the search space or use multiple local search strategies to find the best set of bids. These strategies are still time-consuming and often trade off the quality of the answer found in exchange for shorter runtimes of the computer programs.

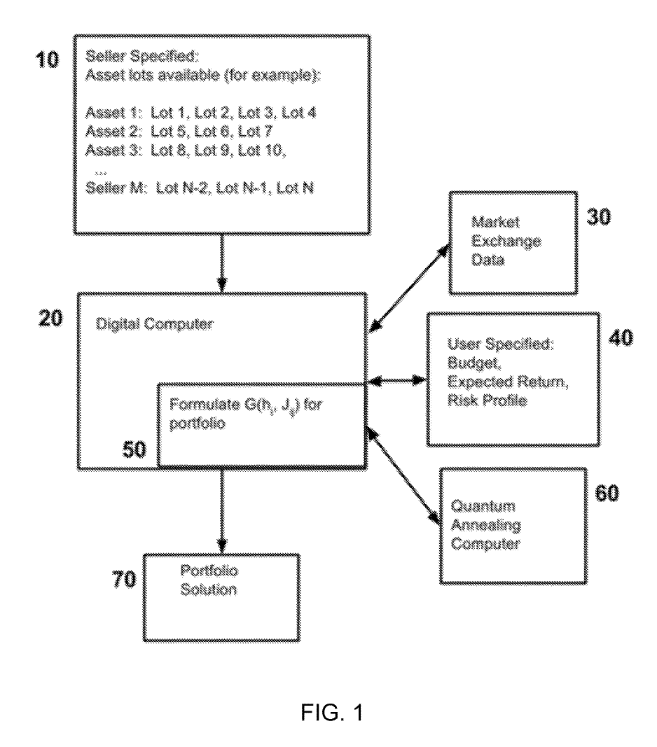

FIG. 1 is a diagram illustrating a financial portfolio optimization method implemented using a quantum processing device. This method formulates the portfolio optimization problem and solves for the best solutions using the power of quantum annealing computers to achieve solutions much faster than existing methods running on traditional digital computer hardware alone.

Referring now to FIG. 1, block 10 is the list of financial assets and lots available to the portfolio manager to purchase. Different assets may be offered by a variety of different sellers and the available assets may include a variety of financial assets. The assets are available for purchase in different lots. For example, Asset 1 (say, a stock for a specific company) is available for purchase as Lot 1, Lot 2, Lot 3 or Lot 4, each of which is a different number of shares of the stock. Each lot comes with a description, in this example, identification of the stocks for different companies, the number of shares in the lot, and the price for the lot, whether it be a special price or simply the market price per share times the number of shares.

Given the financial offerings 10, the method runs on a digital computer 20 and queries the market to download historical financial data 30 to compute the daily rate of return, its variance, and its covariance over a period of time specified by the portfolio manager.

The portfolio manager specifies 40 a budget and an expected rate of return for each stock. There exist a variety of techniques for the portfolio manager to do so.

With the information from 10 and 30, along with the budget and the expected rate of return for each stock from 40, the method then creates 50 an objective function and submits that to the quantum annealing computer 60 to solve for the maximum and minimum expected rate of return from the vast number of portfolios that could be chosen from the various offerings. The resulting maximum and minimum expected rate of returns inform the portfolio manager as to what level of expected return they could target while also optimizing for attendant risk, typically represented as variance in price.

Once the portfolio manager chooses 40 his targeted level of expected rate of return for the entire portfolio, the objective function can be reconstructed 50 to optimize for a desired expected rate of return and minimum variance. The problem is resubmitted to the quantum annealing computer 60 to determine the selection of lots to purchase that meet the budget, expected rate of return, and minimum variance in price.

The result 70 is output to the portfolio manager showing a spectrum of solutions including the optimum along with a number of near-optimum solutions for consideration.

Now consider an example mathematical formulation. The method takes advantage of quantum annealing computers. Such computers solve problems that optimize the objective function

G=−Σᵢhᵢsᵢ−Σ_{i<j}Jᵢⱼsᵢsⱼ (1)

where i is the index for the different available lots, and the hᵢ and Jᵢⱼ are arrays of coefficients to be determined 50 based on the other information 10, 30, 40, as described in more detail below. The sᵢ are a bit string of binary variables (1 or 0) where 1 indicates a particular lot i is in the final solution and 0 indicates the particular lot i is not in the final solution. If there are N possible lots for purchase, then sᵢ will have N number of ones or zeros. The objective function is optimized with respect to the sᵢ.

The task of the formulation step 50 is to convert the information 10, 30, 40 into a mathematical formula of the type solved by the quantum annealing computer 60. In one approach, the overall objective function Gₘₐₓ is formulated to return the portfolio with the maximum return. It includes several components:

Gₘₐₓ=fₚᵣG_{past return}+fₑᵣG_{expected return}+f_{C}G_{cost}

where G_{past return}=Σᵢpᵢ²Var[rᵢ]sᵢ+Σ_{i,j}2pᵢpⱼCov[rᵢ,rⱼ]sᵢsⱼ

G_{expected return}=ΣᵢEᵢsᵢ, or

G_{cost}=2CΣᵢpᵢsᵢ+(Σᵢpᵢsᵢ)(Σⱼpⱼsⱼ) (2)

The first term is based on a component G_{past return} for rate of return based on historical data. The second term is based on a component G_{expected return} for the expected rate of return. The third term is based on a component G_{cost} for the cost or budget allocated to purchase assets. Each component has a relative weight (fₚᵣ, fₑᵣ, f_{C}) which allows the portfolio manager to fine tune the optimization of each component relative to the others.

The past return component G_{past return} is computed based on the price of each lot, pᵢ, and the variance and covariance of each lot's daily rate of return, rᵢ, computed from historical data for the time period specified by the user. Note that rᵢ, will be the same for all lots that are composed of the same assets. A lot with 500 shares of a stock has the same daily rate of return as a lot with 10,000 shares of the same stock.

The component for the expected rate of return G_{expected return} is computed from the expected rate of return Eᵢ of each lot i, for example as determined separately by the portfolio manager.

The component for the budget or cost constraint G_{cost} is computed based on the overall cost allowed, C, and the prices pᵢ of each lot. The form shown above is developed simply by taking the square of the equation expressing the sum of all lots purchased being equal to the cost.

For all of these components, other forms are possible. When the portfolio is computed using the objective function Gₘₐₓ shown in Eq. 2, then the solution from the quantum annealing computer will represent the portfolio with the maximum expected rate of return. Accordingly, the objective function Gₘₐₓ shown in Eq. 2 may be referred to as a maximizing objective function. When the portfolio is computed using the minimizing objective function Gₘᵢₙ shown below:

Gₘᵢₙ=fₚᵣG_{past return}−fₑᵣG_{expected return}+f_{C}G_{cost} (3)

then the solution represents the portfolio with the minimum expected rate of return. Note that the quantum annealing computer does not optimize each component G_{past return}, G_{expected return} and G_{cost} separately. Rather, both Eqs. 2 and 3 can be equated to Eq. 1 and solved for the hᵢ and Jᵢⱼ in Eq. 1.

The portfolio manager can also use the quantum annealing computer 160 to optimize an objective function G_{target} that targets a desired rate of return, E₀:

G_{target}=fₚᵣG_{past return}+fₑᵣG_{expected return}+f_{C}G_{cost}

where G_{expected return}=−2E₀ΣᵢEᵢsᵢ+(ΣᵢEᵢsᵢ)(ΣⱼEⱼsⱼ) and

G_{past return} and G_{cost} are the same as before. (4)

This will now allow solving for the portfolio that optimizes the portfolio with respect to expected rate of return and minimum variance at the same time.

There can be any number of lots considered. As an example, we consider cases where there are 200, 400, and 600 possible lots. The time taken to compute a solution on a quantum annealing computer would be on the order of a second for each case. The time taken to compute a solution on a digital computer increases dramatically with the number of lots considered: about 1 second for the 200 lot case, about 45 seconds for the 400 lot case, and about half an hour for the 600 lot case. Thus, significant speedup can be realized.

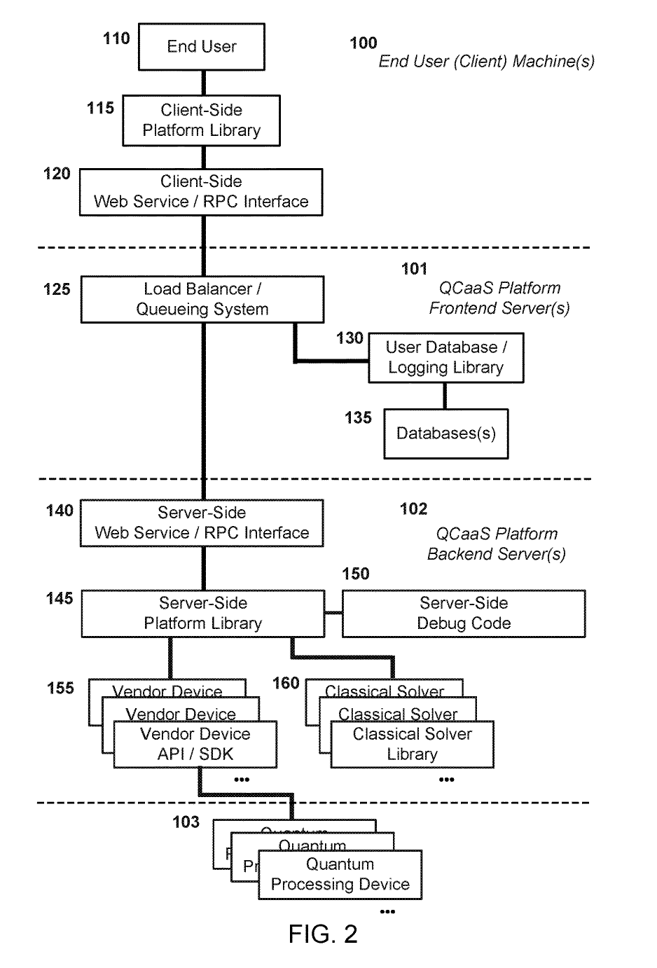

FIGS. 2-4 illustrate one implementation of quantum annealing computers that can be used to solve the financial portfolio optimization problem. In this example, the quantum annealing computer 50 is referred to as a quantum processing device 103.

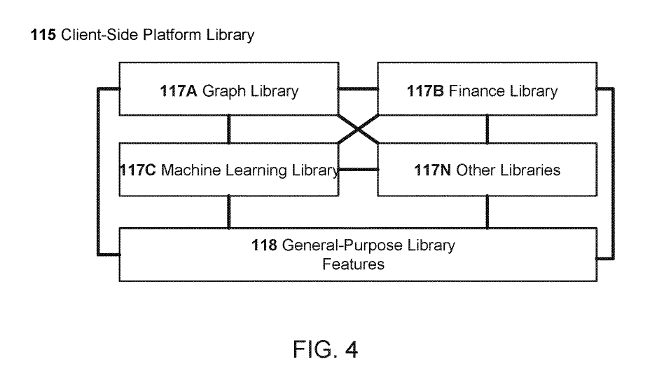

FIG. 2 is a logical diagram of one example of a platform component of a QCaaS (quantum computing as a service) architecture and system, including certain related infrastructure components, suitable for solving the financial portfolio optimization described above. In the diagram, dashed lines indicate boundaries where information passes between different machines and/or logical realms. In the diagram, an end user 110 working on a machine 100 interfaces with a client-side platform library 115 (explained in more detail in FIG. 4). This interaction may be, for example, the user inputting a problem in software code and calling a function in the client-side platform library 115 to pass that problem into the QCaaS system. The client-side platform library 115 then may communicate with a client-side web service or remote procedure call (RPC) interface 120 in order to transmit information about the problem to the remote QCaaS platform, for example in the form of user service requests.

The client-side platform library 115 may have any number of features to expose functionality for and ease the programming burden of the user. For instance, FIG. 4 shows several different modules that may be contained within the client-side library. This example includes a collection of general-purpose software routines, data structures, API endpoints, etc. in block 118. Additionally, the client-side library 115 may include any number of domain-specific libraries: collections of software routines, data structures, API endpoints, etc. that are designed specifically to aid with performing computations for specific domains. Examples include graph analytics 117A, finance 117B, machine learning 117C, or any other domains 117N. The additional libraries 117N need not be domain specific libraries but may be any such additional libraries or modules that add value and functionality to the client-side platform library 115. Preferably, the client-side platform library 115 is designed in such a way as to be extensible by any other such possible modules.

Once the information reaches the remote QCaaS frontend servers 101, the next step is to organize the user requests, for example by routing the information through a load balancer and/or queuing system 125. For instance, if many users are simultaneously using the QCaaS platform, and there are only limited computational resources available through the platform, some of the system preferable will schedule and order the processing of various users' submitted tasks in a reasonable manner. Any number of standard load balancing and queuing algorithms and policies may be used. For instance, one may use a standard round robin algorithm for load balancing.

When this information is passed to the QCaaS frontend servers 101, many potential tasks may be performed. For example, a frontend server 101 may authenticate the user 110 using a database 135 and library 130. The frontend server 101 may also log the information supplied by the user via a logging library 130 and store that information in a database 135. For instance, the frontend server might record copies of the problems that users submit to the platform.

When the load balancer/queuing system 125 deems that a problem is ready to run on the QCaaS system, the information is passed to one or more backend servers 102 in a format governed by a server-side web service/RPC interface 140. The backend servers 102 generally process the user problems to a form suitable for use with quantum processing devices.

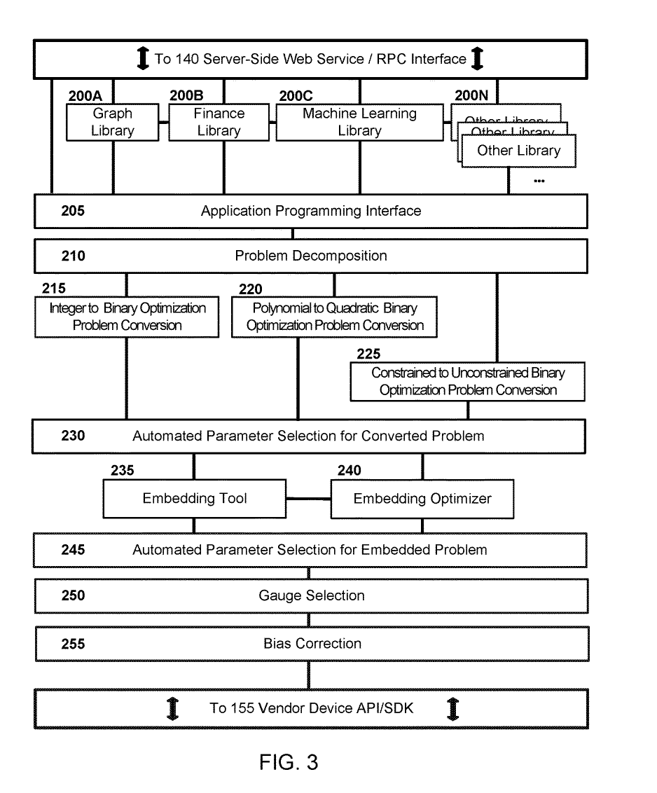

Passing through the backend interface 140, the problem information arrives at the server-side platform library 145 (explained in more detail in FIG. 3). The platform library 145 may interact with debugging libraries 150 or other similar libraries (e.g. logging libraries). The platform library 145 contains a variety of algorithms for taking a computational problem, preparing it for solution on quantum processing devices, executing the computational problem on such devices, and collecting and returning the results. The platform library 145 is not necessarily limited to interacting with just quantum processing devices. One or more classical solver libraries 160 for conventional processing devices may also be used by the platform library 145 for various purposes (e.g. to solve some part of a problem that is not well-suited to a quantum processing solution, or to compare an answer obtained on a quantum processing device to an answer obtainable via a classical solver library).

Generally, though not necessarily, the server-side platform library 145 processes a computational problem and any relevant information about it and passes that processed form onto one or more quantum computing interfaces, such as quantum processing device vendor APIs and/or SDKs 155. For example, if the end user 110 is solving a quadratic binary optimization problem, this problem may be converted by 145 into a form amenable for a D-Wave quantum processing device, whereupon the server-side platform library 145 passes the processed form of the problem to the low-level D-Wave API 155. Low-level APIs like these directly interact with the underling quantum processing devices 103. The quantum processing devices return one or more solutions, and possibly other related information, which are propagated back up the chain, to 155 and then to 145. Solutions and information, e.g. from 150, 155, and 160, are passed to and coalesced by 145. The resulting coalesced data returns to the user, for example via a reverse path through the server-side interface 140, load balancer 125, client-side interface 120, and client-side platform library 115, to finally arrive back at the end user 110.

The quantum processing devices 103 may be one or more physical devices that perform processing especially based upon quantum effects, one or more devices that act in such a way, one or more physical or virtual simulators that emulate such effects, or any other devices or simulators that may reasonably be interpreted as exhibiting quantum processing behavior.

Examples of quantum processing devices include, but are not limited to, the devices produced by D-Wave Systems Inc., such as the quantum processing devices (and devices built upon the architectures and methods) described in U.S. patent application Ser. No. 14/453,883, “Systems and Devices for Quantum Processor Architectures” and U.S. patent application Ser. No. 12/934,254, “Oubit [sic] Based Systems, Devices, and Methods for Analog Processing,” both of which are hereby incorporated by reference in their entirety. Other quantum processing devices are under development by various companies, such as Google and IBM.

Because quantum processing devices operate on qubits, the ability of qubits to exist in superpositions of 0 and 1 allows for greatly enhanced performance for certain computational tasks. For example, Shor's algorithm describes how a quantum processing device can be used to efficiently factor large integers, which has significant applications and implications for cryptography. Grover's search algorithm describes how a quantum processing device can be used to efficiently search a large set of information, such as a list or database. For further examples, see e.g. Shor, 1997, SIAM J. of Comput. 26, 1484; Grover, 1996, Proc. 28th STOC, 212 (ACM Press, New York); and Kitaev, LANL preprint quant-ph/9511026, each of which is hereby incorporated by reference in their entireties.

FIG. 3 is a logical diagram of some of the various software modules and components of the Server-Side Platform Library 145 in FIG. 2, described in accordance with one or more embodiments of the invention. Data flows into and out of the platform library 145 via the interfaces 140,155 at the top and bottom of the diagram, corresponding to connections to other components in FIG. 2.

The platform library 145 may contain one or more domain-specific libraries 200 that may be useful for developing software for or solving problems on quantum processing devices. Each domain-specific library may include software routines, data models, and other such resources as may typically appear in a software library, just as in the case of the client-side platform library 115 shown in FIG. 3. FIG. 3 specifically shows graph analytics 200A, finance 200B, and machine learning 200C as domains where domain-specific libraries and routines may be especially useful, but library 200N emphasizes that any domain-specific library may be incorporated at this layer of the platform library. The numbering 200A-N emphasizes the extensible nature of the platform library. Based upon the components lower down in the diagram, any number of domain-specific libraries 200 may be written and integrated into the platform library 145.

The API 205 exposes the functions, data structures, models, and other core interfaces of the platform library 145. The API 205 may connect with one or more libraries 200A-N and/or may directly communicate with the server-side web service/RPC interface 140, depending on the information being supplied to the platform library 145. The API 205 is responsible for examining a problem and whatever information is supplied to the platform library 145 and determining how to execute the problem on quantum processing devices and/or classical solver libraries, with the help of the remaining modules shown in FIG. 3.

One such module is problem decomposition module 210. The processes conducted by this module involve taking a large problem and splitting it into smaller subproblems, whose solutions may be combined to obtain an exact or approximate solution to the entire problem. For example, if one is solving the Traveling Salesman Problem (TSP) for a large number of cities, there are heuristics in the literature for how to decompose the problem into multiple smaller TSP subproblems over smaller numbers of cities, and to then recombine the solutions of those subproblems into an approximate solution for the overall TSP problem.

An example of a canonical problem decomposition method that may be used in the platform is described in Benders, J. F. Numer. Math. (1962) 4: 238. doi:10.1007/BF01386316, which is incorporated by reference here in its entirety. In Benders' method, an optimization problem is split into an alternating sequence of linear and integer optimization problems that are each easier to solve than the overall optimization problem, which may be nonlinear, non-integer, etc. Benders' method offers certain bounds showing that a solution obtained via the decomposition method is within some approximation of the overall problem's optimal solution.

Another example of a problem decomposition method is the well-known Dantzig-Wolfe decomposition, explained for example on https://en.wikipedia.org/wiki/Dantzig%E2%80%93Wolfe_decomposition, which is incorporated by reference here in its entirety. In the Dantzig-Wolfe method, a linear programming problem of a certain structure is split into a set of subproblems involving distinct subsets of the problem variables. Optimal values of the subproblems are evaluated in the overall problem and are used as the next iterate in the algorithm if the value of the overall problem is improved.

Another potential problem decomposition approach is based on the “randomized search” idea used in, for example, U.S. patent application Ser. No. 13/332,721, which is incorporated by reference here in its entirety. Overall, problem decomposition is especially useful in the context of QCaaS since the currently commercially available quantum processing devices have significantly limited memory. Hence, many problems of practical size must be decomposed in order to fit into the memories of the available quantum processing devices.

The modules, 215, 220, and 225, relate to taking a discrete optimization problem of one form and converting it into a quadratic binary unconstrained form. While certainly not all problems solved on quantum processing devices are discrete optimization problems, the relatively popular D-Wave quantum processing devices have been found to be especially well-suited for this class of problems. Hence, the platform library 145 includes these special modules 215, 220, and 225.

Module 215 uses heuristics to convert an integer optimization problem into a binary optimization problem. One such heuristic operates when the integer formulation of the optimization problem is over a finite set of choices. For instance, if a variable in an integer optimization problem may take on the values 2, 3, or 4, then this may be recast as three binary variables corresponding to (a) whether or not the value is 2, (b) whether or not the value is 3, and (c) whether or not the value is 4, along with some mutual exclusivity constraints between the three binary variables (e.g., the sum of the three binary variables must equal one). While this is a standard heuristic used for integer to binary optimization problem conversion, other heuristics and algorithms may be implemented by module 215 as appropriate.

Module 220 uses heuristics to convert a higher-order polynomial binary optimization problem into a quadratic binary optimization problem. In one embodiment, module 220 use a third-party software library to provide such functionality (indeed, this is generally true of all components of the platform). For instance, module 220 may use the “reduce_degree” utility in the D-Wave low-level API. Another approach is based on adding penalty terms to ensure that ancillas get the correct values (if penalty terms are too small, ancillas may easily obtain the wrong values). Such an approach is documented in arXiv:0801.3625v2 [quant-ph], which is incorporated by reference here in its entirety.

Module 225 uses heuristics involving penalty terms to convert a constrained binary optimization problem into an unconstrained binary optimization problem. One implementation of this module is documented in Pierre Hansen, “Methods of Nonlinear 0-1 Programming,” Annals of Discrete Mathematics, Elsevier, 1979, which is incorporated by reference here in its entirety. Other mathematical techniques for constrained to unconstrained conversion for binary optimization problems will be apparent.

Depending on the input provided to the platform library 145, none, one, some, or all of these modules 215, 220, 225 may be used in order to prepare the problem for solution on the quantum processing devices and/or other solver libraries underlying the platform. Other such modules are certainly possible and may also be used within the platform. For instance, one such module converts formulations of problems that can be run on quantum annealing processing devices (such as the quantum processing devices developed by D-Wave) to formulations that can be run on gate-model quantum processing devices. Such a module may work via “Trotterization,” see e.g. arXiv:1611.00204v2 [quant-ph] (which is incorporated by reference here in its entirety). Another such possible module would convert gate-model formulations of certain problems into formulations amenable to solution on quantum annealing processing devices. Other additional relevant modules may be included at this layer of the platform. The above list is not exhaustive.

Module 230 provides optimizations for the processed problem in order to improve the quality of the solution obtained via the platform. The operations performed are documented in arXiv:1503.01083v1 [quant-ph], which is incorporated by reference here in its entirety. Roughly speaking, we first obtain the strict embedding (the percentage of chains whose qubits all take the same value) for different values of intracoupling strength J_{E}. We then fit this data with a Sigma curve. Next, we use the Sigma curve to determine the point at which the strict embedding is 0.5. Then, for a defined range of values centered at 0.5, we calculate the πₑₗᵢₜₑ value (the best percentage of the obtained logic energies). Finally, we use the J_{E} value that results in the best πₑₗᵢₜₑ.

When the problem is in an optimized state, embedding tools 235, 240 may be run to fit the problem onto a model of the particular hardware architecture of a target quantum processing device. For instance, if a problem is to be solved using a D-Wave quantum processing device, these tools will map the problem onto the chimera graph architecture of that device. The embedding tool 235 may be vendor-supplied or a third-party library, whereas tool 240 can take the output of another embedding tool 235 and provide additional optimizations to make the embedding as compact as possible.

Tool 240 may function by comparing an input problem to similar problems input in the past, and using the good embeddings found for those prior problems as starting points for computing good embeddings for the current input problem. Alternatively, 240 may operate by running the embedding tool 235 multiple times, and choosing the best result to use as the embedding (such may be the mode of operation when tool 235 produces different outputs for different executions). The “best” output of tool 235 may be the embedding with the fewest number of qubits used, the embedding with the shortest chain lengths, or some other criteria that may be specified. Other techniques may be incorporated into the platform for selecting and optimizing embeddings.

The embedded problem (output of tools 235 and/or 240) is then optimized for execution on a specific device via modules 245, 250, 255. One such process is essentially the same process as performed by embedding tool 230. Additionally, for example, with a D-Wave quantum processing device, there are a number of gauges that can be tuned via the low-level D-Wave API, and biases in couplers and local fields (which distort results) may exist in the device. The gauge selection module 250 is based on the techniques in arXiv:1503.01083v1 [quant-ph], which is incorporated by reference here in its entirety.

The idea of this gauge selection method is to study the gauge space. We set a number of gauges that we apply to our embedded problem, and we solve that problem for a given number of runs. Then, using different parameters, such as the πₑₗᵢₜₑ value, we choose the elite gauges based on their scores. Usually these are several gauges that we run more in depth, assuming that they will return better solutions. This metric is usually quite noisy, and thus the choice of several gauges. For bias correction, the platform may use, for example, the D-Wave-provided automatic bias correction feature. Other bias correction strategies are known in the literature, and such strategies may be incorporated into the platform as appropriate as various quantum processing devices become available and mature. Overall, these modules ensure the optimal device-level parameters are automatically selected, obviating the need for the end user 110 to possess deep architecture- and device-specific knowledge in order to obtain high-quality solutions.

Note that the collection of modules in the server-side platform library may be executed iteratively or in the style of a “feedback loop,” where one or more of the modules are executed repeatedly, either in parallel or in serial. For example, one may wish to re-execute both the embedding routines 235 and then the automated parameter selection 245 in order to obtain a better embedding and better parameters for the embedded problem. Generally, many of the modules, e.g. 230, 235, 240, 245, 250, 255, etc., may benefit from multiple executions, and as such, the platform may include options and modes for executing some or all of the modules repeatedly in the style of a feedback loop in order to obtain more suitable results. The platform does not restrict which modules may be run in this iterative fashion.

At the very end of the process, the optimized problem is dispatched to one or more vendor device APIs/SDKs 155. At a later point in time, solutions are returned and are passed back to the end user, as described above and as shown in FIG. 2.

While not shown in FIG. 3, classical solver libraries 165 may be interfaced with FIG. 3 via connections to, for example, one or more of modules 205, 210, 215, 220, and 225. Depending on the classical solver library, other connections may also be possible or appropriate.

Portfolio optimization may be implemented on the QCaaS platform shown in FIGS. 2-4 as follows. The client-side platform library 115 includes a library(ies) for portfolio optimization. Blocks 10, 30, 40 and 70 of FIG. 1 are implemented as part of the client-side platform library 115. Block 50 of FIG. 1 can be split between the client-side platform library 115 and the corresponding server-side platform library 145, for example modules 200 and 225 of FIG. 3. Module 210 of FIG. 3 may also be relevant, for example if the problem as a whole is too large to be solved by a single quantum processing device.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

The term “module” is not meant to be limited to a specific physical form. Depending on the specific application, modules can be implemented as hardware, firmware, software, and/or combinations of these. Furthermore, different modules can share common components or even be implemented by the same components. There may or may not be a clear boundary between different modules, even if drawn as separate elements in the figures.

What is claimed is:

1. A method for optimizing a portfolio of financial assets, comprising:
receiving a list of lots available for purchase, each lot specifying financial assets included in the lot and a price to purchase the lot;
receiving a budget for the portfolio;
formulating an objective function based on the list of lots and on the budget, the objective function having a form suitable for solution by a quantum processing device; and
using the quantum processing device to optimize the objective function, thereby determining which lots are to be purchased.

2. The method of claim 1 wherein the objective function is formulated to minimize or maximize an expected return for the portfolio of purchased lots.

3. The method of claim 1 wherein the objective function is formulated to minimize variance while achieving a target return for the portfolio of purchased lots.

4. The method of claim 3 wherein the objective function has a form:
G_{target}=fₚᵣG_{past return}+fₑᵣG_{expected return}+f_{C}G_{cost}
where G_{past return}=Σᵢpᵢ²Var[rᵢ]sᵢ+Σ_{i,j}2pᵢpⱼCov[rᵢ,rⱼ]sᵢsⱼ
G_{expected return}=−2E₀ΣᵢEᵢsᵢ+(ΣᵢEᵢsᵢ)(ΣⱼEⱼsⱼ)
G_{cost}=−2CΣᵢpᵢsᵢ+(Σᵢpᵢsᵢ)(Σⱼpⱼsⱼ)
where i is an index for the lots; pᵢ is a price of lot i; rᵢ is a rate of return of lot i; Var[ ] and Cov[ ] variance and covariance respectively; Eᵢ is an expected return of each lot i; E₀ is a target return; C is a budget for the portfolio; fₚᵣ, fₑᵣ, f_{C} are relative weights; and sᵢ are binary variables that indicate whether lot i is to be purchased.

5. The method of claim 1 wherein formulating the objective function comprises:
calculating past returns for the financial assets in the lots; and
formulating the objective function further based on the calculated past returns.

6. The method of claim 1 wherein formulating the objective function comprises:
estimating future expected returns for the financial assets in the lots; and
formulating the objective function further based on the estimated future expected returns.

7. The method of claim 1 wherein the objective function includes a term based on past returns for the financial assets in the lots.

8. The method of claim 7 wherein the term is further based on a variance and a covariance of the past returns.

9. The method of claim 1 wherein the objective function includes a term based on expected future returns for the financial assets in the lots.

10. The method of claim 1 wherein the objective function includes a term that avoids exceeding the budget for the portfolio.

11. The method of claim 1 wherein the objective function has a form
G=−Σᵢhᵢsᵢ−Σ_{i<j}Jᵢⱼsᵢsⱼ
where i is an index for the lots, hᵢ and Jᵢⱼ are coefficients based in part on the prices for the lots, and sᵢ are binary variables that indicate whether lot i is to be purchased.

12. The method of claim 1 further comprising:
formulating a maximizing objective function based on the list of lots and on the budget, the maximizing objective function having a form suitable for solution by the quantum processing device;
using the quantum processing device to optimize the maximizing objective function, thereby determining a maximum return for the portfolio;
formulating a minimizing objective function based on the list of lots and on the budget, the minimizing objective function having a form suitable for solution by the quantum processing device;
using the quantum processing device to optimize the minimizing objective function, thereby determining a minimum return for the portfolio; and
receiving a desired return for the portfolio; wherein the desired return is between the minimum return and the maximum return and the objective function is further based on achieving the desired return while reducing risk.

13. The method of claim 1 wherein some of the lots are for the same asset but in different quantities.

14. The method of claim 1 wherein the quantum processing device optimizes the objective function in less than one minute.

15. The method of claim 1 wherein receiving the list of lots and formulating the objective function are performed by a conventional processing device, the conventional processing device configuring the quantum processing device to optimize the formulated objective function.

16. A computer system for optimizing a portfolio of financial assets, comprising:
a digital computer that executes software to:
receive a list of lots available for purchase, each lot specifying financial assets included in the lot and a price to purchase the lot;
receive a budget for the portfolio; and
formulate an objective function based on the list of lots and on the budget, the objective function having a form suitable for solution by a quantum processing device; and
a quantum processing device coupled to the digital computer, the digital computer configuring the quantum processing device to optimize the objective function, thereby determining which lots are to be purchased.

17. The computer system of claim 16 wherein the objective function is formulated to minimize variance while achieving a target return for the portfolio of purchased lots.

18. A platform for providing quantum computing as a service, the platform comprising:
a client side interface;
a frontend server that receives user service requests from a plurality of users via the client side interface, the user service requests to be performed on quantum processing devices not dedicated to or directly accessible by any of the users, the frontend server organizing the user service requests;
a server side interface;
a backend server that receives the user service requests from the frontend server via the server side interface, the backend server processing the user service requests to a form suitable for quantum processing devices; and
a quantum computing interface, the backend server transmitting the user service requests to the quantum processing devices via the quantum computing interface;
wherein the user service requests include requests for optimizing a portfolio of financial assets, the backend server including a server side portfolio optimization library that processes the user service requests for optimizing the portfolio of financial assets to a form suitable for the quantum processing devices.

19. The platform of claim 18 wherein the frontend server includes a client-side portfolio optimization library.

20. The platform of claim 18 wherein the backend server comprises a plurality of different server side platform libraries, the plurality of different server side platform libraries including the server side portfolio optimization library.
